(19) United States
(12) Patent Application Publication
(10) Pub. No.: US 2013/0094697 A1
(43) Pub. Date: Apr. 18, 2013

(54) CAPTURING, ANNOTATING, AND SHARING MULTIMEDIA TIPS

(71) Applicants: John ADCOCK, San Francisco, CA (US); Scott CARTER, Los Altos, CA (US); Anthony DUNNIGAN, Palo Alto, CA (US); Petri RANTANEN, Pori (FI)

(72) Inventors: John ADCOCK, San Francisco, CA (US); Scott CARTER, Los Altos, CA (US); Anthony DUNNIGAN, Palo Alto, CA (US); Petri RANTANEN, Pori (FI)

(73) Assignee: FUJI XEROX CO., LTD., Tokyo (JP)

(21) Appl. No.: 13/272,894

(22) Filed: Oct. 13, 2011

(51) Int. Cl. G06K 9/00

(52) U.S. Cl. 382/103

(57) ABSTRACT

Systems and methods are provided herein that can help people share tacit knowledge about how to operate and repair products in their environment. Systems and methods provided herein let users record video and improves the usefulness of recorded content by helping users add annotations and other meta-data to their videos at the point of capture.

### BACKGROUND

1. Field

The exemplary embodiments are directed to creating multimedia, and more specifically, to capturing, annotating, and sharing multimedia tips.

2. Description of the related art

In most organizational environments, a significant amount of knowledge transfer occurs not through official talks or documents but rather in the form of the unscheduled, brief interchange of tacit information. Many systems have attempted to help capture or augment this type of transfer, but it is difficult to encapsulate this kind of information in a way that is easy to replicate and share.

Mobile devices are particularly well suited to capturing and sharing otherwise ephemeral information since they are usually at hand and are highly personalized and flexible, often including front-facing as well as rear-facing cameras allowing for photo and video preview from a variety of user angles. Also, recent work has shown that people already are capturing a variety of multimedia information about products with their phones, including not only hardware but also computer and device screens.

### SUMMARY

Aspects of the exemplary embodiments involve an apparatus, including a camera receiving video feed; and a product identification module identifying a product from the video feed and retrieving information regarding the product.

Aspects of the exemplary embodiments may further involve a method, including receiving video feed from a camera; identifying a product from the video feed; and retrieving information regarding the product.

Aspects of the exemplary embodiments may further involve an apparatus, including a camera recording video from a video feed; a product identification module identifying a product from the video feed and retrieving information regarding the product; a bookmark creation module generating a bookmark in the recorded video, the bookmark including annotation and a tag generated from the retrieved information.

It is to be understood that both the foregoing and the following descriptions are exemplary and explanatory only and are not intended to limit the embodiments or the application thereof in any manner whatsoever.

### BRIEF DESCRIPTION OF THE DRAWINGS

FIG. 1 illustrates the basic flow of events for searching tips from the database in accordance to an exemplary embodiment.

FIG. 2 illustrates the interface for OCR scan in accordance to an exemplary embodiment.

FIG. 3 illustrates functionalities of the result list in accordance to an exemplary embodiment.

FIG. 4 illustrates the user interface for viewing bookmarks and captures in accordance to an exemplary embodiment.

FIG. 5 illustrates the flow of events and actions for creating a new tip and bookmark in accordance to an exemplary embodiment.

FIG. 6 illustrates a flowchart for adding bookmarks while video is recorded in accordance to an exemplary embodiment.

FIG. 7 illustrates an exemplary user interface for capturing the videos in accordance to an exemplary embodiment.

FIG. 8 illustrates an exemplary overview screen for captured videos and bookmarks, allowing the user to edit the basic details of the tip in accordance to an exemplary embodiment.

FIG. 9 illustrates an interface for editing a capture in accordance to an exemplary embodiment.

FIG. 10 illustrates an exemplary flowchart for filtering out black frames in accordance to an exemplary embodiment.

FIG. 11 is a block diagram that illustrates an embodiment of a computer/server system upon which an embodiment of the inventive methodology may be implemented.

### DETAILED DESCRIPTION OF THE INVENTION

The exemplary embodiments of the invention described here help users create tips for product operation and repair. A tip may contain one or more videos each of which can include any number of multimedia bookmarks. Bookmarks are associated with a time in the video and contain a timestamp, a keyframe (or frame from the video selected to represent the video), a name, and one or more annotations, each of which can contain any or all of: a short textual description of the bookmark; a high-resolution photo; a short audio clip, and a region marker that highlights a portion of the video frame at the time-code associated with the bookmark. In addition to its associated bookmarks, each tip can be given a name, an owner, a short description, as well as any number of text tags. Certain embodiments of the invention save videos, bookmarks, and annotations locally to the mobile device. When the user submits a tip each component is serialized, transmitted to the server, and stored in a database. Associated media files (videos, images) are stored on the server file system and referenced by path name in the database.

A search function allows the user to search tips from the database. The tips are created by other users of the system. The search system also includes a rating system, which allows users to vote for the quality and usefulness of the tip. The server maintains a record of votes cast for each tip which is updated whenever a user casts a vote.

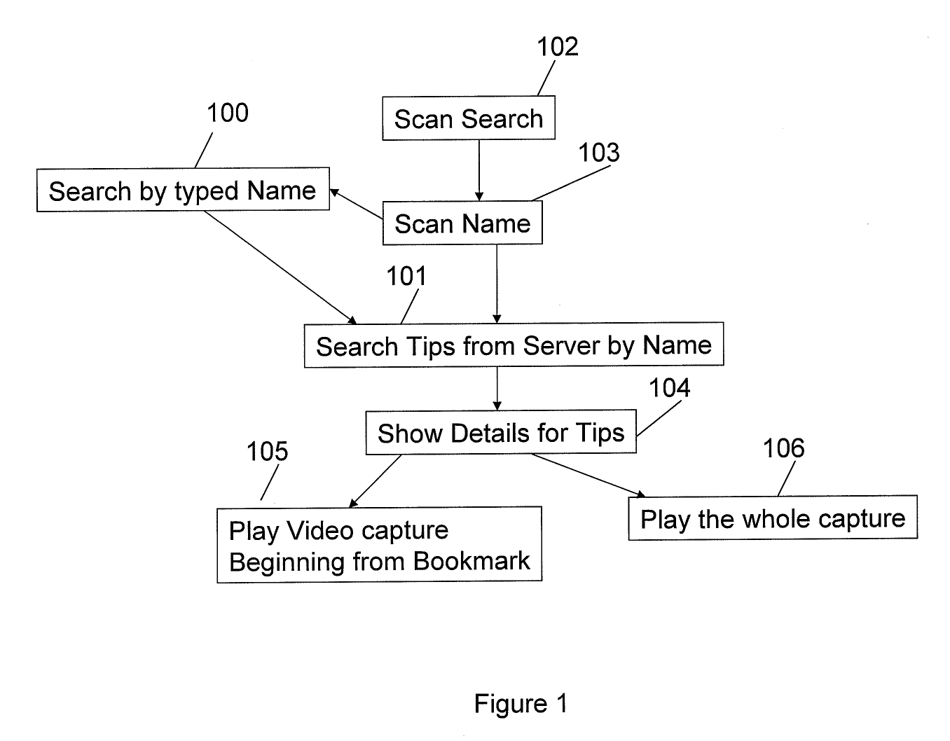

FIG. 1 illustrates the basic flow of events for searching tips from the database in accordance to an exemplary embodiment. There are several search options available for the user. One option is to manually input a text search 100 to search the tip database by name 101. Another option is to use the camera feed to scan a product 102 for a product name by Optical Character Recognition (OCR) or other methods 103, with the option of allowing the user to cancel and manually input text as needed 100. When using OCR (scan name) the words (or phrases of text) recognized by the OCR system on the mobile device are automatically submitted to the server and matched against a database which contains previously submitted tips 104. If matching tip names are found, then they are returned and displayed in a list of results to the user. Information about each tip is displayed in the list, including the tip title, a representative keyframe, and a list of bookmarks associated with the tip organized by the video in which they appear. If a user clicks on the title or keyframe the application will begin playing the tip from the beginning of the first video 106. If the user clicks on a bookmark the application will first seek the corresponding video to that bookmark's timestamp before playing 105.

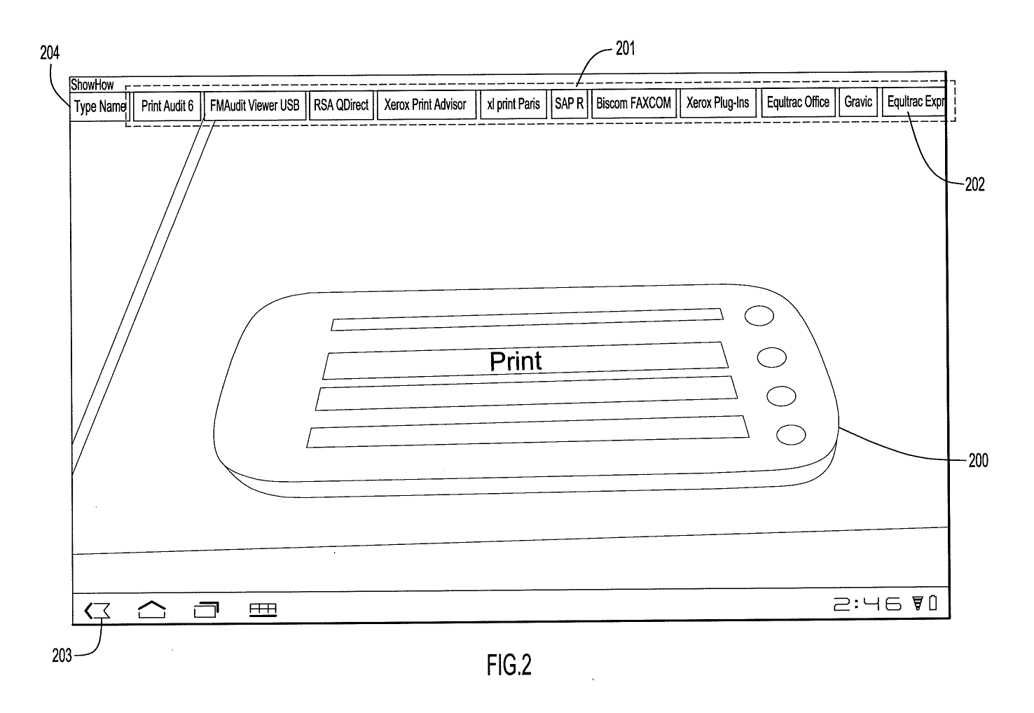

FIG. 2 illustrates the interface for OCR scan in accordance to exemplary embodiments. The scan can be canceled at any point in case the user wants to type the search term manually instead 204, or if no results are found. The OCR scan processes the video frames 200 and generates a list of results 201 that the user may select 202 to associate with the video or in creating a bookmark. The user can scroll through the list or results 201 by gesturing in a direction, and the OCR system can be paused while the user cycles through the list. The user may exit the live OCR scan 203 if needed to return back to the previous screen of the interface. If the apparatus taking the video frames shakes or moves, an accelerometer may be used to detect the movement and update the camera focus.

Approaches other than OCR may also be used to search for products. For example, the server may store richer representations of products including high resolution photos or 3D models, or analyze such photos for image features. In this case, the mobile device could send an image as a query in addition to or instead of OCR text. The server could then attempt to match the image against its database of photos or 3D models to identify the object of interest, by using image features within the image. Those versed in the art will appreciate that feature-point based methods such as but not limited to those invented by Lowe form a basis for retrieval of images of similar objects.

Whether the user types the search term manually or uses the OCR scan or visual functionality to search for one, the search is always performed the same way. The selected query is submitted to the server and matching results are found based on similarity between the query and the tip contents. A list of the most similar tips is returned and shown to the user.

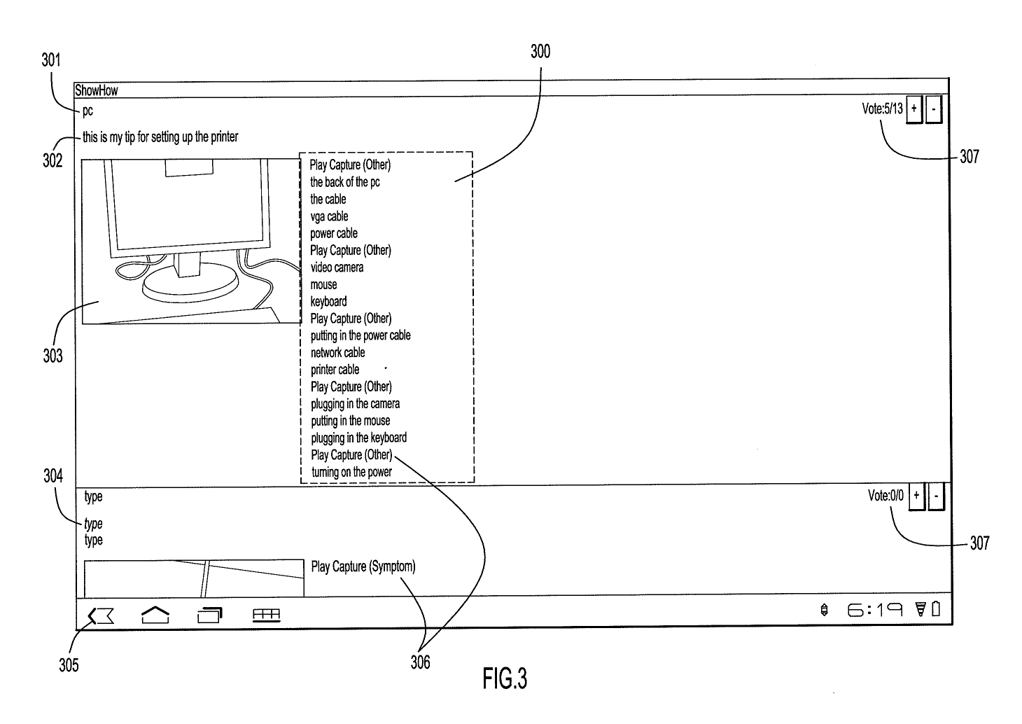

FIG. 3 illustrates functionalities of the result list in accordance to an exemplary embodiment. The result list entry shows an overview of the tip and its contents (such as the list of captures and bookmarks from the tip 300, the name of the tip 301 and its description 302, or information about the type of video, such as a video about a symptom, solution or other 306) and an automatically generated preview image 303 for each tip. The interface also allows users to see how others have rated (voted on) the tip and they can submit their own votes 307.

From the list of results the user can either choose to play a video capture from the beginning or select an individual bookmark (FIGS. 1 and 3). When a user selects a bookmark the playback starts from its time-code and continues to the end of the capture.

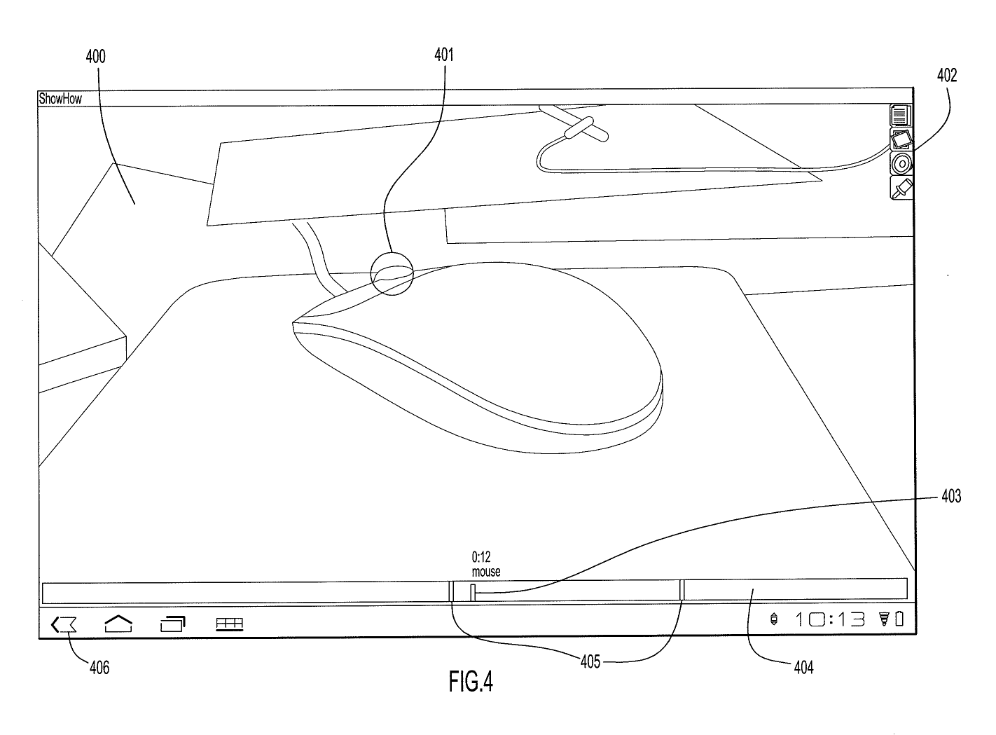

FIG. 4 illustrates the user interface for viewing a video capture and its component bookmarks in accordance to an exemplary embodiment.

In the video player 400 the user can play or pause the video and view the content associated with the capture in the seekbar 404, which can be clicked or gestured on for seeking to parts of the video. The user can swipe left or right to move to the previous or next bookmark if needed. The example provided in FIG. 4 is the video at bookmark 403 for a product 401. The content may include multiple bookmarks 405 and each bookmark can include any combination of the available media annotations 402, including text (a description of the bookmark and its contents), high resolution picture, audio clip, and region on the video. Icon representations can be created for each type of annotation, with greyed out icons indicating annotations that were not set, and color for set annotations. The user may also edit the annotations as needed. When the user is finished viewing the capture, an exit option is also provided 406.

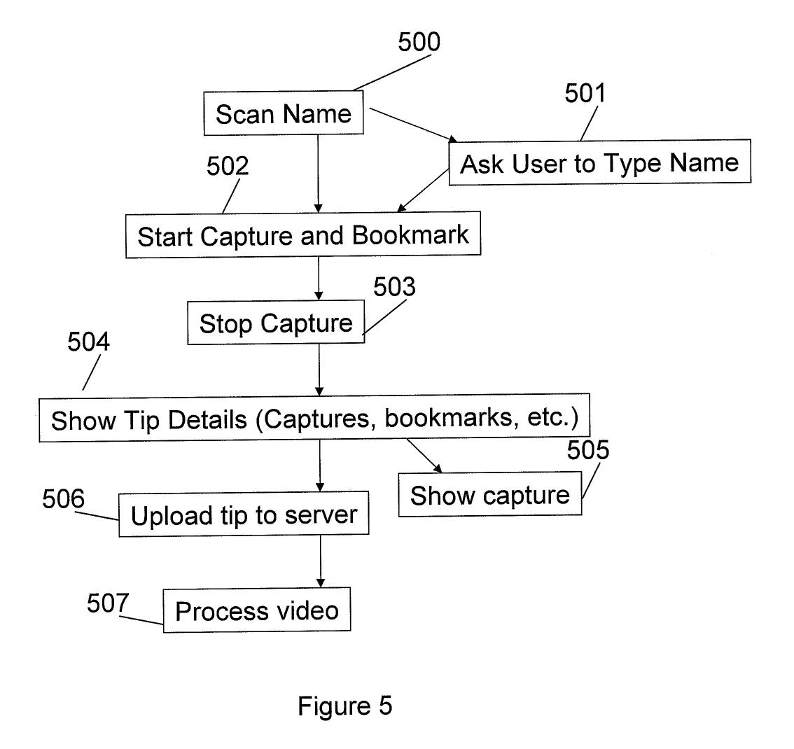

FIG. 5 illustrates a flowchart for showing the flow of events and actions for creating a new tip, in accordance to an exemplary embodiment. Selecting a name for the tip is similar to the process of selecting a name when searching for a tip, in that the name can be scanned from the product in the video frame 500 or the user can manually input the name 501. In comparison to searching a tip manually, the OCR results are not necessarily compared against the list of previously submitted tips, but an alternative database can be used instead. This database may include use case specific details (for example a list of printer model names) or it can be a generic list of terms.

After choosing a name for the tip, the user can record a video capture 502. While recording, the user can touch the screen to add a bookmark at the current time. In the background, the application creates a bookmark with empty annotation values and associates it with the current time in the video. The application also extracts a video frame from that time and associates it with the bookmark. The user can capture all the videos for a tip immediately after the scanning step, but it is also possible to capture additional videos after stopping the capture 503 and reviewing 505 and editing the current set of video captures and any bookmarks made 504.

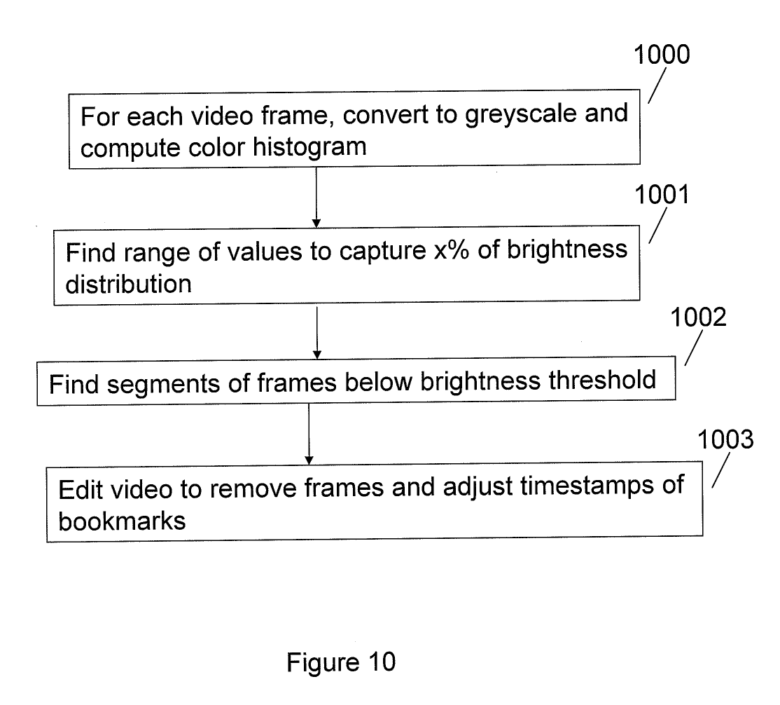

More captures can be added at any time, and the same is true for modifying the capture, bookmark, and tip details. It should be apparent to one knowledgeable in the art that a tip previously created and submitted to the server 506 could be later altered by editing on a mobile device if such functionality was useful. Videos can be further processed 507 to remove black frames, as explained below in the description for FIG. 10. In addition to black frame removal other sorts of post-processing may be performed on video captures, such as image stabilization or contrast enhancement.

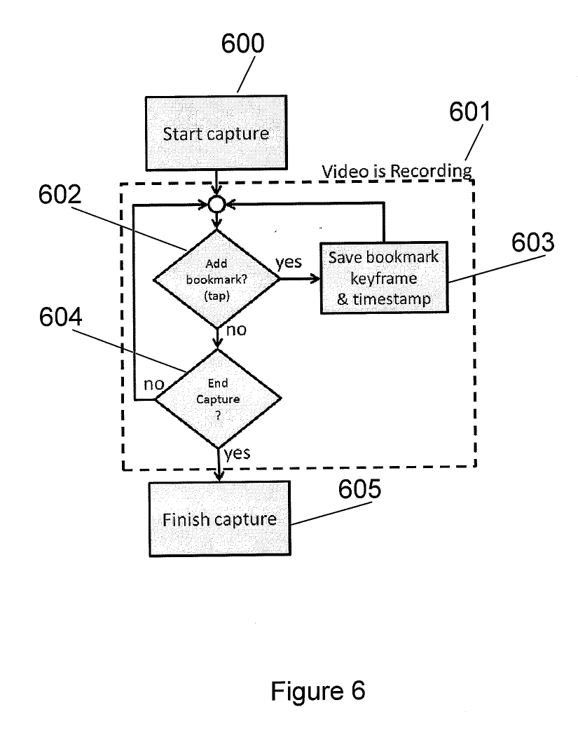

FIG. 6 illustrates a flowchart for adding bookmarks while video is recorded in accordance to an exemplary embodiment. The user initiates the capture of video 600. While the video is recording 601, the user may instruct the system to initiate a bookmark at any time during the recording 602. When a bookmark is created, the timestamp and the key frame may be saved 603. Once the user instructs the system to stop recording, 604, the capture ends 605.

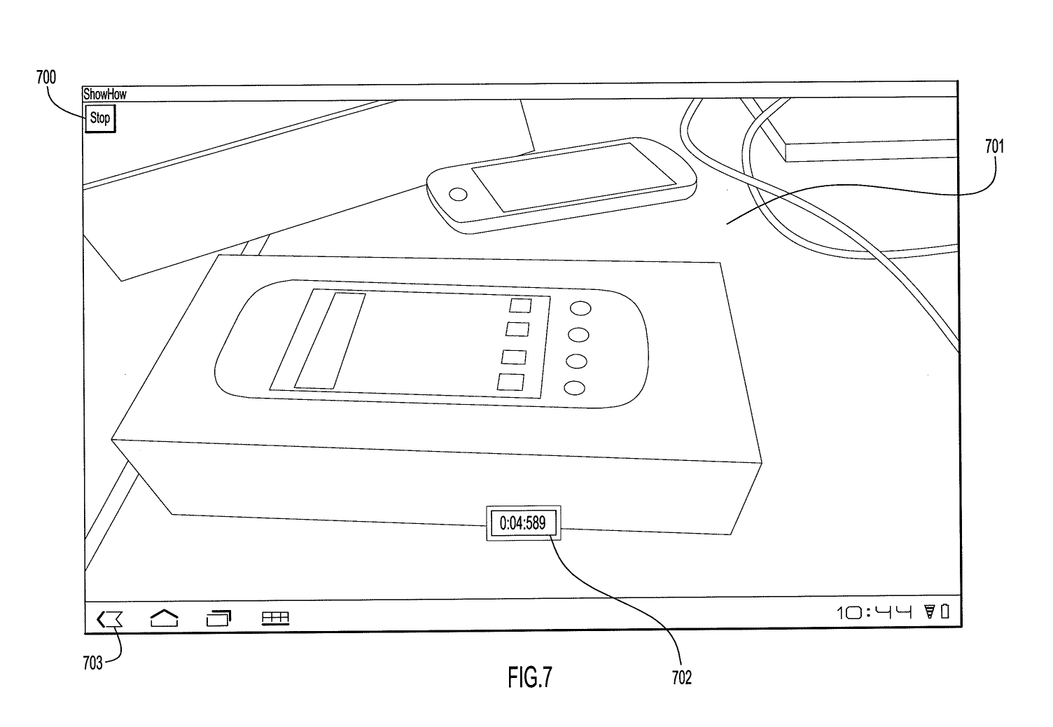

FIG. 7 illustrates a user interface for capturing videos in accordance to an exemplary embodiment. When creating a new tip the user is offered the possibility to start a capture 700. While the video is being captured, the user may tap the screen 701 to generate a bookmark. When a bookmark is created, a visual indication 702 may be provided which may also include the timestamp of the bookmark in reference to the recorded video. Pressing the button 700 again ends the capture. After each capture the user may choose to record another capture, or to review and edit the set of captures and bookmarks for the current tip.

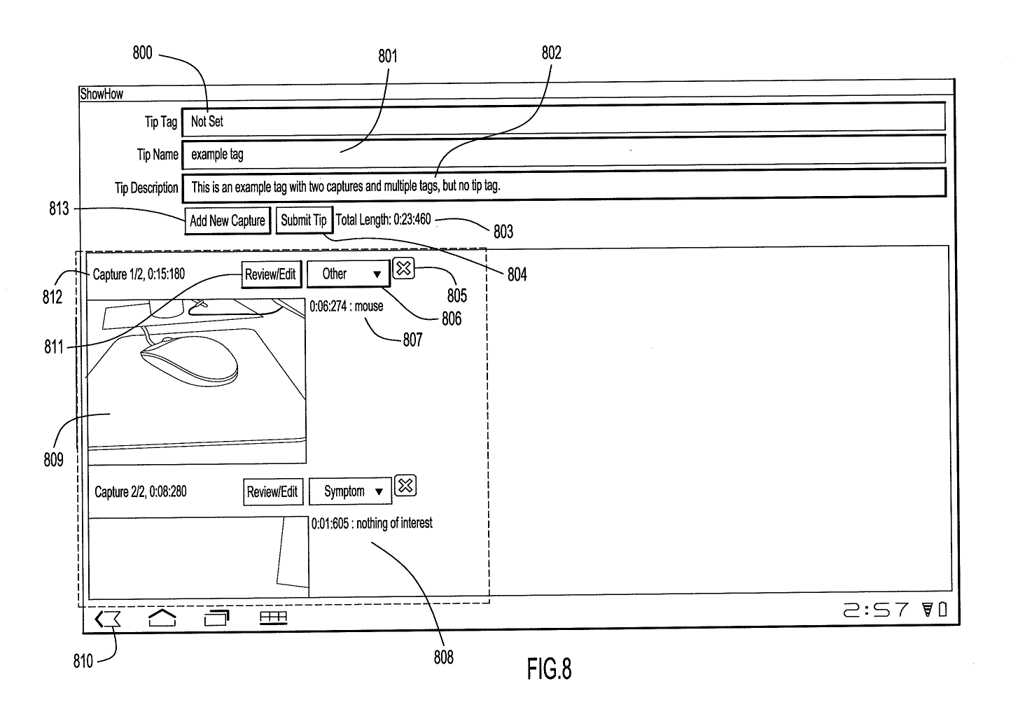

FIG. 8 illustrates an exemplary overview screen for captured videos and bookmarks comprising a tip, allowing the user to edit the basic details of the tip in accordance to an exemplary embodiment. These details include setting the name 801 and description 802 for the tip, the length of the tip 803 and optional text tags 800 which apply to the entire tip. From this screen the user can also choose to record a new capture 813, delete previously recorded captures 805, and edit, delete or rename bookmarks 811, or submit new tips 804. Bookmark details can be provided 807 which can include the bookmark name and the timestamp. A list of captures and bookmarks can also be provided that are associated with the video 808. Each capture can include a capture type parameter 806 which can be used to help structure the tip. The possible capture types are symptom, solution, and other. Capture information, such as video length, number of captures, and capture duration can also be provided 812. By clicking the Review/Edit button 811 or by clicking a bookmark image user 809 can go to the edit capture mode. The user may also abort the changes 810.

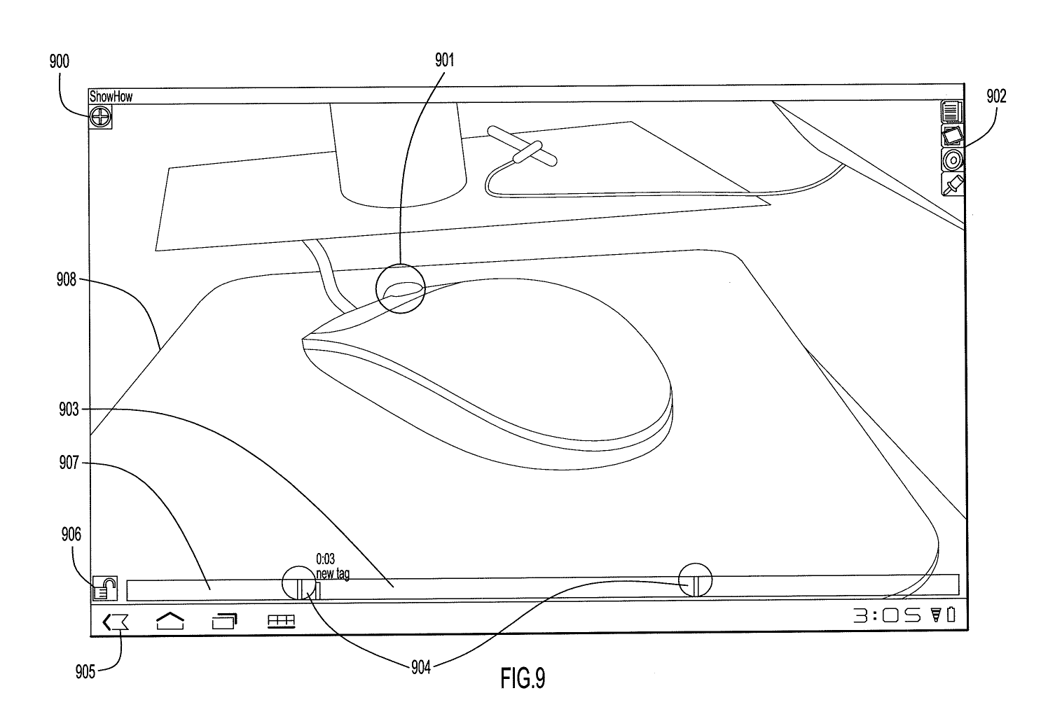

FIG. 9 illustrates an interface for editing a video capture in accordance to an exemplary embodiment. The interface for editing a capture of a product 901 at a particular bookmark of the video 903 is similar to the interface for viewing the capture, but in the edit mode additional controls are available. The user can play or pause the video by tapping on the screen 908 and view or alter the contents of the associated bookmarks. The seek bar 907 can be used to jump to a point in the video, and bookmarks within the seek bar may be locked or unlocked to enable or disable the modification of bookmarks 906. New bookmarks can be added 900 and the positions of the existing bookmarks can be adjusted 904, by double clicking on the seek bar 907. Using the icons in the right edge of the screen 902 user can add annotations to the current bookmark or replace the previously added annotations. At any time the user can press the back button 905 to return to the overview screen. All modifications made during editing the capture are automatically saved locally to the device.

When all the necessary details are added, such as a tip name and description, and a name for each bookmark, the tip can be uploaded (submitted) to the server. If user did not provide all of the required information the tip cannot be uploaded and a message is shown describing what details are missing. After the tip has been uploaded the server will automatically process the captured video clips for removal of black frames or other purposes.

Once a tip and its associated captures are uploaded to the server, a variety of media processing can be performed offline.

FIG. 10 illustrates an exemplary flowchart for filtering out black frames in accordance to an exemplary embodiment. Each video frame is converted to greyscale colorspace and a color histogram is computed 1000. A range of brightness values is computed for all of the video frames such that a x % percentage of the frames falls within the range 1001. x % can be specified by the user or derived from the brightness distribution. Frames falling outside of the range are removed 1002, and the timestamps of the bookmarks associated with the videos are updated to account for the removed frames 1003. If the tip author puts the mobile device face down while making a capture. the captured video will be completely black and is not useful for other tip users. While video processing on the mobile device may be limited (the device is already capturing and compressing the video on the fly) black segments can be easily identified and removed as a post-processing step on the tip server. In a simple implementation, a frame may be considered to be a black frame if the proportion of pixels with brightness below a preset threshold (e.g., 0.1 on a scale of 0.0-1.0) is above a second threshold (e.g., 90%). In a slightly more flexible approach, a frame may be considered to be black if some preset proportion of the brightness (e.g., 90%) is contained within a predetermined range of values (e.g., 0.1 of the brightness value range). This approach has the property that it can detect nearly monochromatic frames at any black or white point and doesn't depend upon a true black color. Once black frames are identified, segments of consecutive black frames longer than a predetermined time (e.g., 0.2 seconds) which do not coincide with a user-entered bookmark or annotation can be edited out. The server will need to adjust the time stamps of the bookmarks associated with the capture to preserve their timing. The server may save a record of the edits (an edit list) which is used to adjust the bookmark timestamps on demand. In this way the edits created by the black frame removal are non-destructive and the system has the option of ignoring the black frame edits and displaying the original video.

Exemplary implementations of the exemplary embodiments are provided below. The following are hypothetical scenarios that illustrate how certain embodiments of the invention operate.

Ekim, a senior technician, heads out to a partner site to fix a problem with the Deluxe 9000-AX multifunction device. He also carries his mobile device to document the problem. Right away he can tell that the problem is likely a blown fuse. He opens his mobile device and using an exemplary embodiment, begins recording the first clip. The mobile device suggests that he names the video “Deluxe 9000-AXE”, which it recognized from video frames of the device. As he then makes his recording, Olga passes by and asks him about his child's cricket match. Ekim places his phone down to chat with Olga, knowing that this part of the video will be removed automatically in accordance to the flowchart of FIG. 10. He stops talking, picks up the device, and resumes filming. He clicks the screen when showing the fuse itself and then wraps up his video. He then opens up the bookmark edit view, swipes the screen to go to the bookmark he made, drags a pin over to highlight the fuse, and finally adds a high resolution video of the blown fuse. Back in the capture list view, he sets the capture as a “symptom” and then records a second video showing how to replace the fuse. When Ekim is done he bookmarks the tip as “blown fuse” and submits it to the server.

Rakaj, a rookie technician, is having difficulty identifying a problem with a device he is servicing. He can tell that the problem is likely electrical, but otherwise is stumped. He searches the video archive for the device, “Deluxe 8050” and gets 12 responses back. He scans through video keyframes until he comes across one that seems to look the most like the issue he is facing on a very similar device. He clicks on the keyframe to start the video and sees that the problem is indeed similar to his. He then sees that it has been bookmarked as a “blown fuse” and goes back to the beginning to watch the rest of the video. When he finishes he gives the video a positive vote and then fixes the problem.

The exemplary embodiments thereby provide a mobile application for capturing, editing, storing, and searching “tips” composed of videos and associated multimedia annotations that document product operation and repair. The systems of the exemplary embodiments include a variety of mechanisms to help tip creators augment videos with meta-data that can help other users search the archive of tips. Specifically, the systems of the exemplary embodiments utilize a mobile application capture and edit one or more video clips and associated multimedia annotations of those clips which are then uploaded to a server.

The exemplary embodiments allow users to record multiple video clips to be associated with a tip; allow users to augment video clips with bookmarks, where bookmarks can have one or more multimedia annotations including: audio, still image, text, and marks placed on the captured videos and allows users to upload tip contents (videos, bookmarks, and their annotations) to a server to host authored tips for later retrieval.

The exemplary embodiments may use OCR of live video frames to help find product names in the database; use OCR of live video frames to help search for product tips; use image features of live video frames to help find product names in the database; and use image features of live video frames to help search for product tips.

The exemplary embodiments can also use speech-to-text engines to generate searchable text for bookmarks from the video clip's audio track; and post-process submitted videos to automatically remove unwanted segments.

The exemplary embodiments also provide a mobile retrieval and playback platform for video tips with various affordances to navigate among bookmarks, view bookmarks, skip between bookmarks while watching video playback.

The exemplary embodiments may also provide additional functionality to allow users to provide feedback (positive or negative) about submitted tips, and allow users to override OCR tools to enter product names or search tips via standard text entry.

By implementing the exemplary embodiments, users can document product issues they uncover in the field using their mobile phone to take videos that they can then annotate with a variety of multimedia annotations. These media are sent to a database that other users can search. Like many mobile applications, it is necessary to find a balance between ease-of-use and expressivity. If the application does not provide enough documentation support users capturing information will be frustrated. On the other hand, if the tool forces the users into too many unnatural tasks they will abandon it entirely. Similarly, users searching for help should he able to find information with minimal overhead. To address these issues, additional aspects of the exemplary embodiments that can help bootstrap documentation while also improving search are provided below.

Bookmark editing, annotation, and other meta-data: While recording video, users can click the screen to add a time-based bookmark without stopping the recording. After they finish recording, users can then move, delete, and annotate bookmarks with a variety of media. Users can also categorize captures as symptoms of a problem or solutions to a problem.

Live search: The integration of live OCR into the tool for both capture and search is useful to automatically set the product name without requiring text entry, which not only aids users uncomfortable with text entry on mobile devices, but also helps improve the consistency of the database. Users can launch a live video view that sends keyframes to a local OCR engine. The OCR engine extracts text from the scene and sends it to a server, which returns a scored list of products.

Speech-to-text: If the users capturing video do not add annotations to a bookmark, the exemplary embodiments can automatically select audio from the captured video in a time window around the bookmark and apply speech to text conversion. If the speech is converted with a high enough confidence, the text can be used as a searchable annotation. A tip author may utter some descriptive speech while recording a tip, in particular while marking a bookmark during capture. To help make this speech useful, speech recognition, or speech-to-text, may be employed on the server. The captured audio in the immediate neighborhood of a bookmark can be extracted for speech-to-text processing. The speech-to-text may be performed by some external service or with a local process. If speech is recognized with a good confidence level it can be added to the searchable bookmark text to aid text-based retrieval of tips.

Black frames: After a video is submitted, the exemplary embodiments can cull sections of videos that were clearly not meant to be viewed, such as long sequences of black frames. This allows users capturing video to set their mobile device aside while it is recording so that they can focus on the objects they are documenting.

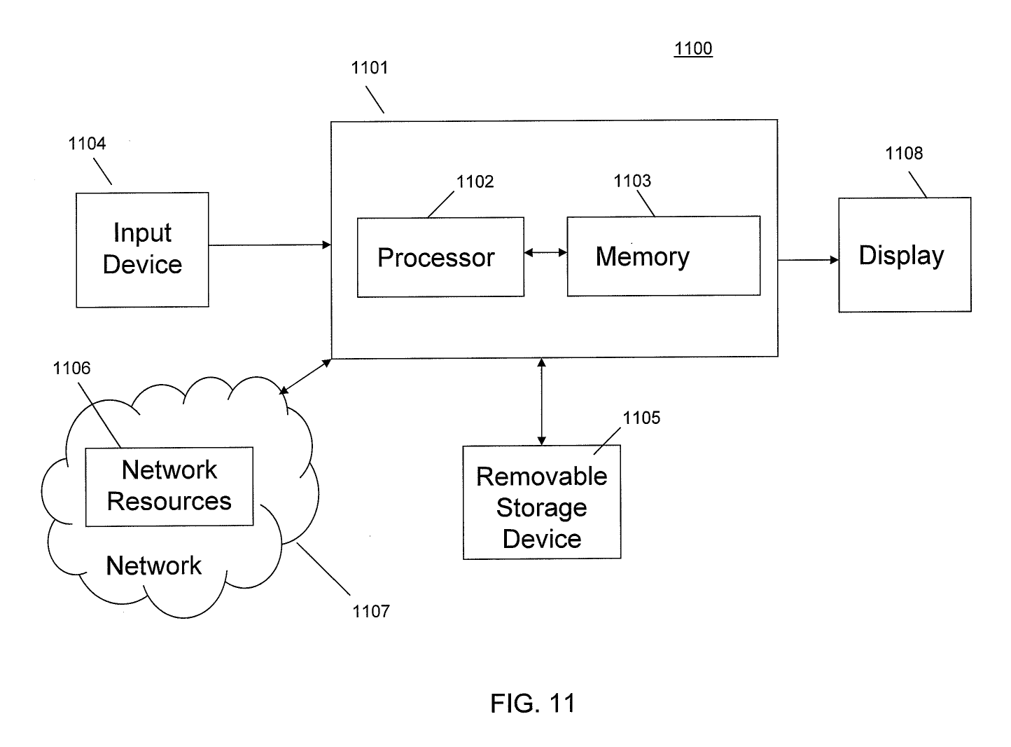

FIG. 11 is a block diagram that illustrates an embodiment of a computer/server system 1100 upon which an embodiment of the inventive methodology may be implemented. The system 1100 includes a computer/server platform 1101 including a processor 1102 and memory 1103 which operate to execute instructions, as known to one of skill in the art. The term “computer-readable medium” as used herein refers to any medium that participates in providing instructions to processor 1102 for execution. Additionally, the computer platform 1101 receives input from a plurality of input devices 1104, such as a keyboard, mouse, touch device or verbal command. The computer platform 1101 may additionally be connected to a removable storage device 1105, such as a portable hard drive, optical media (CD or DVD), disk media or any other medium from which a computer can read executable code. The computer platform may further be connected to network resources 1106 which connect to the Internet or other components of a local public or private network. The network resources 1106 may provide instructions and data to the computer platform from a remote location on a network 1107. The connections to the network resources 1106 may be via wireless protocols, such as the 802.11 standards, Bluetooth® or cellular protocols, or via physical transmission media, such as cables or fiber optics. The network resources may include storage devices for storing data and executable instructions at a location separate from the computer platform 1101. The computer interacts with a display 1108 to output data and other information to a user, as well as to request additional instructions and input from the user. The display 1108 may therefore further act as an input device 1104 for interacting with a user.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An apparatus, comprising:
a camera receiving video feed;
a product identification module, comprising a processor, identifying a product from the video feed and retrieving information regarding the product.

2. The apparatus of claim 1, wherein the product identification module identifies the product by conducting optical character recognition (OCR) on the video feed and matching a result against a database of existing product names.

3. The apparatus of claim 1, wherein the product identification module identifies the product by matching image features from the video feed against a database of image features.

4. The apparatus of claim 1, wherein the information regarding the product comprises a tip regarding repair of the product, the tip comprising a video bookmark and an annotation.

5. The apparatus of claim 1, wherein the information regarding the product comprises a video regarding operation of the product.

6. The apparatus of claim 1, further comprising a recording module storing video recorded from the video feed of the camera, wherein the stored video is tagged with the information regarding the product.

7. A method, comprising:
receiving video feed from a camera;
identifying a product from the video feed, using a processor; and
retrieving information regarding the identified product.

8. The method of claim 7, wherein the identifying is conducted by using optical character recognition (OCR) on the video feed and matching a result against a database of existing product names.

9. The method of claim 7, wherein the identifying is conducted by using image features in the video feed and matching the image features against a database of image features.

10. The method of claim 7, wherein the retrieving information further comprises retrieving a video bookmark and an annotation regarding repair of the product.

11. The method of claim 7, wherein the retrieving information further comprises retrieving video regarding operation of the product.

12. The method of claim 7, further comprising storing video recorded from the video feed of the camera, wherein the stored video is tagged with the information regarding the product.

13. An apparatus, comprising:
a camera recording video from a video feed;
a processor;
a product identification module using the processor to identify a product from the video feed and retrieving information regarding the product.
a bookmark creation module using the processor to generate a bookmark in the recorded video, the bookmark comprising annotation and a tag generated from the retrieved information.

14. The apparatus of claim 13, wherein the product identification module identifies the product by using optical character recognition (OCR) on the video feed and matching a result against a database of existing product names.

15. The apparatus of claim 13, wherein the product identification module identifies the product by using image features in the recorded video and matches the image features against a database of image features.

16. The apparatus of claim 13, further comprising a video processing module identifying and removing black frames in the recorded video.

17. The apparatus of claim 13, wherein the bookmark further comprises an image extracted from the recorded video.

18. The apparatus of claim 13, further comprising a bookmark placement module placing the bookmark in a specified time stamp within recorded video.
